(19) United States
(12) Patent Application Publication
(10) Pub. No.: US 2003/0174374 A1
(43) Pub. Date: Sep. 18, 2003

(54) Scanning optical system

(75) Inventor: Shuichi Takeuchi, Saitama-ken (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/315,995

(22) Filed: Dec. 11, 2002

(30) Foreign Application Priority Data
Dec. 11, 2001 (JP) 2001-376823

(51) Int. Cl. G02B 26/08

(52) U.S. Cl. 359/205; 359/212; 359/215; 359/216

(57) ABSTRACT

A scanning optical system includes a light source that emits a laser beam, a deflector that deflects the laser beam emitted by the light source to scan, and an imaging optical system that converges the scanning beam (deflected beam) on an objective surface so that a beam spot scan on the objective surface in a main scanning direction. There is provide a cemented optical element between the deflector and the objective surface. The cemented optical element is configured to be a combination of a base component and a photo-curing resin layer having a diffractive lens structure formed on the outward surface thereof. Alternatively, a thermo-curing resin layer may be provided instead of the photo-curing resin layer.

### BACKGROUND OF THE INVENTION

The present invention relates to a scanning optical system that is used for a scanning optical device such as a laser beam printer. Particularly, the present invention relates to a scanning optical system including a diffractive-lens structure to compensate for chromatic aberration caused by refractive lenses.

A scanning optical system having the above-described configuration is disclosed, for example, in Japanese Patent Provisional Publications Nos. HEI 10-197820 and HEI 10-68903. In the scanning optical systems disclosed in the publications, a laser beam emitted by a light source such as a laser diode is deflected by a polygonal mirror, and is converged, through an fθ lens (i.e., a scanning lens), on an objective surface such as a surface of a photoconductive drum to form a beam spot. The beam spot formed on the objective surface moves (i.e., scans) thereon in a predetermined scanning direction (i.e., a main scanning direction) as the polygonal mirror rotates. One surface of the fθ lens is formed with a diffractive lens structure to correct chromatic aberration caused by the refractive lens structure.

In this specification, a scanning direction of the beam spot on the objective surface is referred to as the “main scanning direction”, and a direction perpendicular to the main scanning direction on the objective surface is referred to as an “auxiliary scanning direction”. Shapes and orientations of powers of respective optical elements will be defined with reference to the scanning directions on the objective surface.

The scanning optical system disclosed in the Publication No. HEI 10-197820 has a diffractive lens structure that is a part of rotationally symmetrical pattern to compensate for lateral chromatic aberration in the main scanning direction due to optical dispersion of material of the fθ lens. The scanning optical system disclosed in the Publication No. HEI 10-68903 has a similar diffractive lens structure to reduce a variation of magnification and movement of a focusing point due to thermal expansion and change of refractive index of a plastic lens caused by temperature change. The optical element having the diffractive lens structure is made by glass molding or injection molding of plastic resin. A pattern of the diffractive lens structure is formed on a molding die and is transformed to the molded lens.

However, it is difficult to accurately transform the pattern of the diffractive lens structure onto a lens surface by the conventional forming method (i.e., glass molding or injection molding of plastic resin). That is, since viscosity of the plastic resin or glass is relatively high at a molding temperature, the lens material (i.e., the plastic or glass) may not fill in the minute pattern of the diffractive lens structure formed on the molding die. Thus, the portions of the thus formed lens corresponding to the minute pattern are likely to have rounded edge shape.

Further, shrinkage of the lens during cooling stage, i.e., when the temperature is lowered from the molding temperature to room temperature, may cause sagging and/or crack of the diffractive lens structure. If a diameter of an optical element is several millimeters, such a defect due to the thermal shrinkage will not be fatal because of its small shrinkage amount. However, if the diameter of the fθ lens is larger than several tens of millimeters, the defect has a deleterious effect on the optical performance because of its large shrinkage amount.

### SUMMARY OF THE INVENTION

The present invention is advantageous in that there is provided a scanning optical system having an optical element provided with diffractive lens pattern which can be transferred from a molding die accurately, without causing sagging and/or crack.

According to an aspect of the invention, there is provided a scanning optical system including a cemented optical element located between a deflector and an objective surface. The cemented optical element is configured to be a combination of a base component and a photo-curing resin layer having a diffractive lens structure formed on the outward surface thereof.

Alternatively, a thermo-curing resin layer may be provided instead of the photo-curing resin layer.

Optionally, the base component of the cemented element is made of thermoplastic resin formed in accordance with an injection molding process. Alternatively, the base component of the cemented element is made of glass.

In some embodiments, the cemented element has a function of a lens as a whole, while in another embodiment, the cemented element only contributes to compensate for aberrations.

In particular, the imaging optical system may include a refractive optical element, and the diffractive lens structure may compensate for aberration caused by characteristics of said refractive optical element in a main scanning direction. In this case, the aberration may be lateral chromatic aberration.

Further optionally, the imaging optical system may include a plurality of optical elements, and the cemented optical element may be one of the plurality of optical elements.

Alternatively, the imaging optical system includes only one optical element, which also functions as the cemented optical element.

In a particular case, the cemented optical element is not included in the imaging optical system.

### BRIEF DESCRIPTION OF THE DRAWINGS

FIG. 1 is a diagram showing an arrangement of optical elements of a scanning optical system according to a first embodiment;

FIG. 2 is an enlarged view of a cemented lens included in the scanning optical system shown in FIG. 1;

FIG. 3 is a front view of the cemented lens shown in FIG. 2;

FIG. 4 is a sectional view of a molding device for manufacturing the cemented lens shown in FIG. 2;

FIG. 5 is a graph showing lateral chromatic aberration of the scanning optical system of the first embodiment;

FIG. 6 is a diagram showing an arrangement of optical elements of a scanning optical system according to a second embodiment;

FIG. 7 is a graph showing lateral chromatic aberration of the scanning optical system of the second embodiment;

FIG. 8 is a diagram showing an arrangement of optical elements of a scanning optical system according to a third embodiment;

FIG. 9 is a graph showing lateral chromatic aberration of the scanning optical system of the third embodiment;

FIG. 10 is a diagram showing an arrangement of optical elements of a scanning optical system according to a fourth embodiment; and

FIG. 11 is a graph showing lateral chromatic aberration of the scanning optical system of the fourth embodiment.

### DETAILED DESCRIPTION OF THE PREFERRED EMBODIMENTS

Scanning optical systems according to embodiments of the invention will be described with reference to the accompanying drawings. The scanning optical system of each embodiment can be employed in a laser scanning unit of a laser beam printer. The scanning optical system scans a laser beam modulated by an input signal onto an objective surface to be scanned such as a photoconductive drum to form a latent image thereon.

First Embodiment

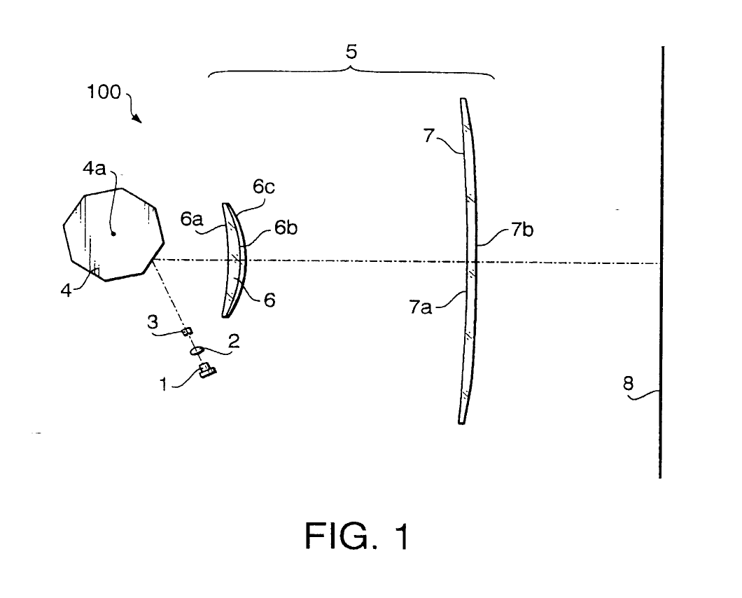

FIG. 1 is a diagram illustrating a basic construction of a scanning optical system 100, on a plane perpendicular to the auxiliary scanning direction, according to the first embodiment.

A divergent laser beam emitted by a laser diode (light source) 1 is collimated by a collimating lens 2 and converged in the auxiliary scanning direction by a cylindrical lens 3, and is incident on a polygonal mirror (deflector) 4 which rotates about an rotation axis 4a extending in the auxiliary scanning direction. The laser beam deflected by a reflection surface of the polygonal mirror 4 forms a beam spot on an objective surface 8 through an fθ lens 5.

The power of the cylindrical lens 3 is determined such that a line-shaped image is formed in the close proximity to the reflection surface of the polygonal mirror 4. The line-shaped image is re-converged by the fθ lens and a circular beam spot is formed on the objective surface 8. With this configuration, a so-called facet error of the polygonal mirror is cancelled.

The fθ lens 5 includes a first lens 6 and a second lens 7 arranged in this order from the polygonal mirror 4 to the objective surface 8. The first lens 6 is a positive meniscus lens whose concave surface faces the polygonal mirror 4. The first lens 6 is located near the polygonal mirror 4. The second lens 7 is located near the objective surface 8, and has a positive power mainly in the auxiliary scanning direction.

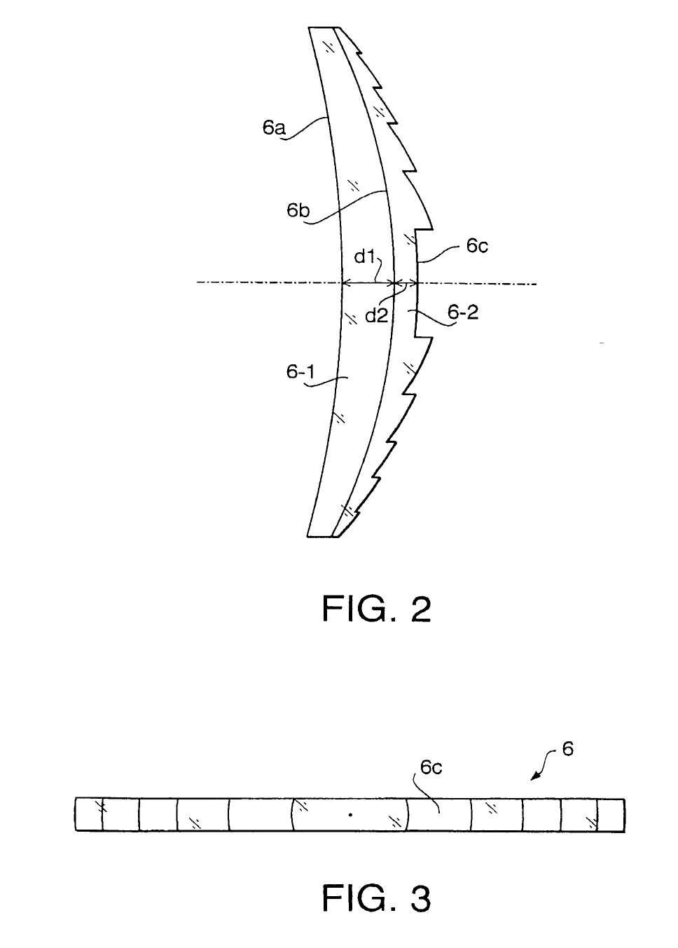

The construction of the first lens 6 will be described in detail. FIG. 2 is an enlarged view of the first lens 6 and FIG. 3 is a front view of the first lens viewed from the objective surface side.

The first lens 6 is a cemented lens (a cemented element) that includes a base lens (a base component) 6-1 made of thermoplastic resin and a photo-curing resin layer 6-2 formed on a surface of the base lens 6-1. As shown in FIG. 2, the photo-curing resin layer 6-2 has a diffractive lens structure formed on the outer surface, i.e., on a beam exiting surface 6c (hereinafter the beam exiting surface 6c is occasionally referred to as a diffractive surface). The diffractive lens structure is formed as a part of rotationally symmetrical pattern as shown in FIG. 3 to compensate for lateral chromatic aberration in the main scanning direction due to optical dispersion of material of the fθ lens 5. It should be noted that the number of ring areas shown in FIG. 2 is smaller than the actual number and the minute steps in FIG. 3 are exaggerated for the purpose of illustration.

A beam incident surface 6a, which is a polygonal mirror side surface, of the first lens 6 is a spherical surface. The cemented surface 6b and a base curve of the diffractive surface 6c are rotationally symmetrical aspherical surfaces. The base curve is defined as a shape of the surface, on which the diffractive lens structure is formed, excluding the diffractive lens structure.

A beam incident surface 7a of the second lens 7 is an anamorphic aspherical surface whose shape in the main scanning direction is expressed as a function of a distance from the optical axis, and whose shape in the auxiliary scanning direction is expressed as another function of a distance from the optical axis. A beam exiting surface 7b, which is an objective surface side surface, is a rotationally symmetrical aspherical surface.

A manufacturing method of the first lens (the cemented lens) 6 will be described. The manufacturing method includes the following four steps.

(a) Step for forming the base lens 6-1 made of thermoplastic resin.

(b) Step for setting the base lens 6-1 in a molding device to form a cavity corresponding to the shape of the photo-curing resin layer 6-2.

(c) Step for charging photo-curing resin into the cavity.

(d) Step for curing the photo-curing resin by applying light.

In step (a), the base lens 6-1 is formed by injection molding or grinding.

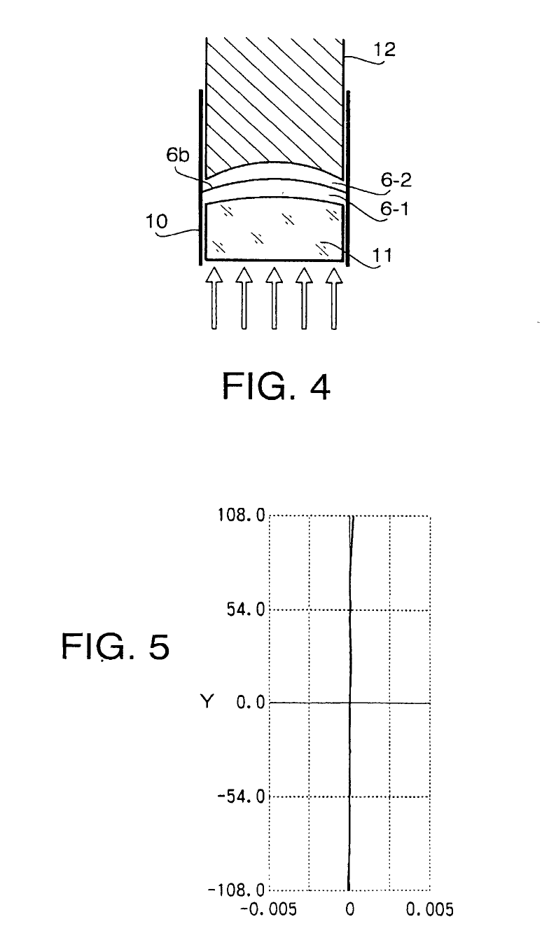

In step (b), the base lens 6-1 is set in the molding device as shown in FIG. 4. FIG. 4 is a sectional view of the molding device that includes an outer frame 10, a glass stopper 11 and a molding die 12. The base lens 6-1 is inserted in the outer frame 10. The glass stopper 11 having a diameter same as that of the base lens 6-1 is also inserted in the outer frame 10 to support the base lens 6-1 from the beam incident surface side (the lower side in FIG. 4). While there is no need to match the shape of the surface of the glass stopper 11 that contacts the base lens 6-1 with the shape of the base lens 6-1 because the glass stopper 11 is not used as a molding die, it is preferable that the glass stopper 10 well fits the base lens 6-1 to ensure the positioning accuracy. The molding die 12 is inserted in the outer frame 10 from the opposite side of the glass stopper 11 to form a cavity corresponding to the shape of the photo-curing resin layer 6-2. The surface of the molding die 12 that faces the base lens 6-1 has a pattern to form the diffractive lens structure.

In step (c), the photo-curing resin is charged into the cavity formed between the cemented surface 6b and the molding die 12.

In step (d), ultraviolet light is projected from the lower side as shown by arrows in FIG. 4. The ultraviolet light transmits through the glass stopper 1-1 and the base lens 6-1, illuminating the photo-curing resin charged in the cavity. The photo-curing resin reacts to the ultraviolet light and cures in accordance with the form of the cavity.

Through the above method, the photo-curing resin layer 6-2 provided the diffractive lens structure is formed on the cemented surface 6b of the base lens 6-1, thereby forming the cemented lens 6.

It should be noted that the above method is an exemplary method, and can be modified. For example, in steps (b) and (c), the molding die 12 may be inserted after the resin material is charged onto the surface 22a of the second lens 22.

Since the photo-curing resin is an easy-flow material at room temperature, it can fill in the minute pattern of the diffractive lens structure formed on the molding die 12. Accordingly, the pattern can be transformed easily and accurately to the photo-curing resin layer 6-2, which ensures that an excellent optical performance as designed is achieved.

Further, since the photo-curing resin layer 6-1 cures at a room temperature, there is no thermal shrinkage, which prevents problems during heat treatment such as sagging and crack of the diffractive lens structure.

A thermosetting resin layer may be used instead of the photo-curing resin layer 6-1. In such a case, a stopper made of heat-resistant material such as metal and ceramics is employed instead of the glass stopper 11 and heat is applied to the thermo-curing resin.

TABLE 1 shows the numerical construction of the scanning optical system 100 according to the first embodiment from the polygonal mirror 4 to the objective surface 8.

Symbol f in TABLE 1 represents a focal length of the fθ lens 5 in the main scanning direction, fb represents a distance from the final surface of the fθ lens 5 to the objective surface 8, ry represents a radius of curvature (unit: mm) of a surface in the main scanning direction, rz represents a radius of curvature (unit: mm) of a surface in the auxiliary scanning direction (which will be omitted if a surface is a rotationally-symmetrical surface), d represents a distance (unit: mm) between surfaces along the optical axis, n represents a refractive index of an element and vd is an Abbe number of the element.

A surface number 0 represents the reflection surface of the polygonal mirror 4, surface numbers 1 through 3 represent the beam incident surface 6a, the cemented surface 6b and the diffractive surface 6c of the first lens 6, and surface numbers 4 and 5 represent the incident and beam exiting surfaces 7a and 7b of the second lens 7.

TABLE 1
f = 200.1 mm fb = 90.0 mm

| Surface Number | ry | rz | d | n | νd |
|---|---|---|---|---|---|
| 0 | ∞ | — | 36.0 | — | — |
| 1 | 10 −124.0 | — | 8.0 | 1.486 | 57.4 |
| 2 | −55.2 | — | 0.2 | 1.522 | 42.7 |
| 3 | −55.2 | — | 106.9 | — | — |
| 4 | −760.0 | 29.0 | 4.0 | 1.486 | 57.4 |
| 5 | −3000.0 | — | — | — | — |

The cemented surface 6b (surface number 2), the base curve of the diffractive surface 6c (surface number 3) and the beam exiting surface 7b (surface number 5) of the second lens 7 are rotationally symmetrical aspherical surfaces. A rotationally symmetrical aspherical surface is expressed by the following equation:

$$X ( h ) = \frac{{Ch}^{2}}{1 + \sqrt{1 - ( 1 + κ ) {h}^{2} {C}^{2}}} + {A}_{4} {h}^{4} + {A}_{6} {h}^{6} + {A}_{8} {h}^{8}$$

where X(h) is a sag, that is, a distance of a curve from a tangential plane at a point on the surface where the height from the optical axis is h, C is a curvature (1/r) of the surface on the optical axis, κ is a conic constant, A₄, A₆ and A₈ are aspherical surface coefficients of fourth, sixth and eighth orders, respectively.

The conic constants and the aspherical coefficients that define the rotationally symmetrical aspherical surfaces are shown in TABLE 2.

TABLE 2

| Surface | | | | |
|---|---|---|---|---|
| Number | κ | A₄ | A₆ | A₈ |
| 2 | 0.000 | 3.200 × 10⁻⁷ | 0.000 | 0.000 |
| 3 | 0.000 | 3.200 × 10⁻⁷ | 0.000 | 0.000 |
| 5 | 0.000 | −7.840 × 10⁻⁸ | 0.000 | 0.000 |

It should be noted that the radii of curvature of the aspherical surfaces indicated in TABLE 1 are values on the optical axis.

The incident side surface 7a (surface number 4) of the second lens 7 is an anamorphic aspherical surface. The shape of the surface 7a in the main scanning direction is expressed by the non-circular arc curve expressed by the following equation:

$$X ( y ) = \frac{{Cy}^{2}}{1 + \sqrt{1 - ( κ + 1 ) {C}^{2} {y}^{2}}} + {AM}_{4} {y}^{4} + {AM}_{6} {y}^{6} + {AM}_{8} {y}^{8}$$

where C is a curvature (1/ry) of the surface in the main scanning direction on the optical axis, AM₄, AM₆, and AM₈ are aspherical surface coefficients of fourth, sixth and eighth orders, respectively.

A radius of curvature of the surface 7a in the auxiliary scanning direction varies in accordance with the distance y from the optical axis in the main scanning direction. The radius of curvature rz(y) of the surface 7a in the auxiliary scanning direction at the point where the distance from the optical axis is y is expressed by the following equation:

$$\frac{1}{rz ( y )} = \frac{1}{rz0} + {AS}_{1} y + {AS}_{2} {y}^{2} + {AS}_{3} {y}^{3} + {AS}_{4} {y}^{4} + {AS}_{6} {y}^{6}$$

where, rz0 is a radius of curvature in the auxiliary scanning direction on the optical axis, AS₁, AS₂, AS₄ and AS₆ are coefficients that define the radius of curvature in the auxiliary scanning direction of first, second, third, fourth and sixth orders, respectively.

The coefficients that define the surface 7a are shown in TABLE 3.

TABLE 3

| | | | |
|---|---|---|---|
| ry | −760.0 | rz0 | 29.0 |
| κ | 0.000 | AS₁ | −6.000 × 10⁻⁷ |
| AM₄ | 5.000 × 10⁻⁸ | AS₂ | −1.330 × 10⁻⁶ |
| AM₆ | −5.500 × 10⁻¹² | AS₃ | 0.000 |
| AM₈ | 1.900 × 10⁻¹⁶ | AS₄ | 4.000 × 10⁻¹¹ |
| — | — | AS₆ | 0.000 |

The diffractive surface 6c of the first lens 6 is formed by applying the diffractive lens structure on the rotationally symmetrical aspherical base curve. The diffractive lens structure is defined by an additional optical path length added thereby. The additional optical path length is expressed by the following optical path difference function Φ(h):

Φ(h)=(P₂h²+P₄h⁴+P₆h⁶)×λ

where P₂, P₄ and P₆ are coefficients of second, fourth and sixth orders, h is a height from the optical axis and λ is a wavelength of an incident light beam. The optical path difference function Φ(h) shows optical path difference between an imaginary ray that was not diffracted by the diffractive lens structure and a diffracted actual ray that are incident on the diffractive lens structure at the same point whose distance from the optical axis is h. The coefficients that define the diffractive surface 6c are shown in TABLE 4.

TABLE 4

| Surface Number | P₂ | P₄ | P₆ |
|---|---|---|---|
| 3 | −9.000 × 10⁻² | −3.500 × 10⁻⁵ | 0.000 |

FIG. 5 is a graph showing lateral chromatic aberration of the scanning optical system 100 according to the first embodiment. The graph plots a deviation of a beam spot formed by a laser beam at wavelength 790 nm in the main scanning direction with reference to a beam spot formed by a laser beam at the design wavelength 780 nm. The vertical axis of the graph represents an image height (height of scanning spot on the objective surface 8 from a point where the optical axis intersects the objective surface 8), the horizontal axis represents amount of the deviation of the beam spot, and the unit is millimeter for both axes. FIG. 5 shows that the diffractive lens structure formed on the diffractive surface 6c compensates for the lateral chromatic aberration. The pattern of the diffractive lens structure can be accurately transformed onto the photo-curing resin layer 6-2, which ensures an excellent optical performance as designed. This can reduce a variation of drawing performance even if the emission wavelength of the light source varies. For instance, when the scanning optical system 100 is employed in a multi-beam scanning optical device that scans a plurality of laser beams simultaneously, it is able to prevent a variation among lengths of scanning lines due to a difference in wavelength.

Second Embodiment

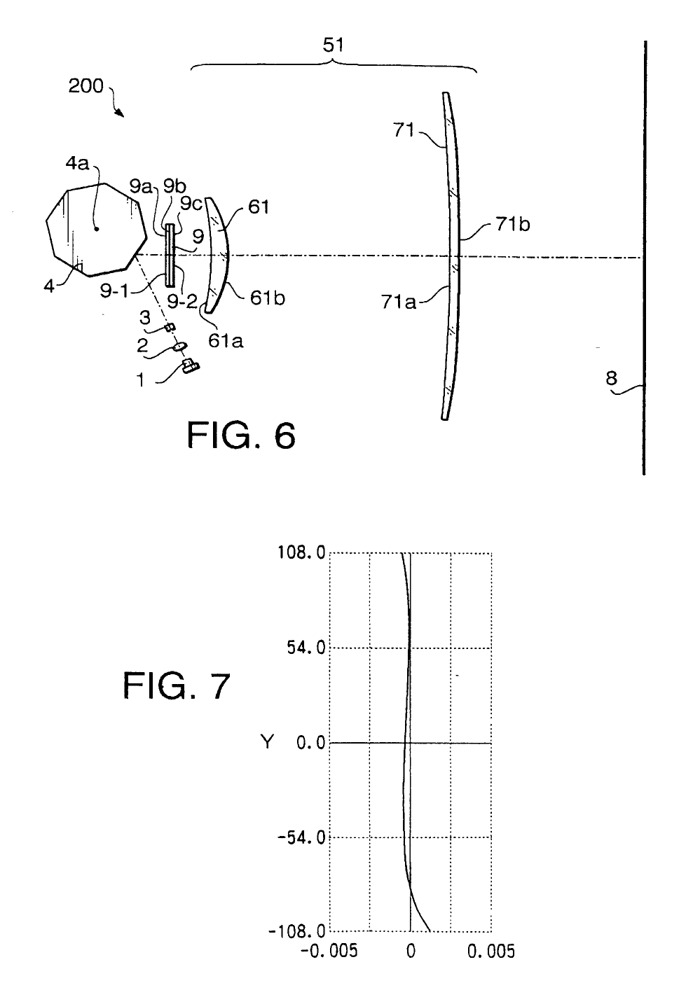

FIG. 6 is a diagram illustrating a basic construction of a scanning optical system 200 according to the second embodiment.

The scanning optical system 200 is provided with the laser diode 1, the collimator lens 2, the cylindrical lens 3, the polygonal mirror 4 and an fθ lens 51 in the same manner as the first embodiment.

According to the second embodiment, the polygonal mirror 9 is accommodated in a dust-proof and/or sound-insulating casing (not shown). The casing is provided with a cover glass 9 for allowing the laser beam to pass through, and the diffractive lens structure is provided on the cover glass 9.

As shown in FIG. 6, and similarly to the first embodiment, a laser beam emitted by the laser diode 1 passes through the collimating lens 2, the cylindrical lens 3, a first transparent plate (not shown) provided to the casing and is incident on the polygonal mirror 4. The laser beam deflected by the polygonal mirror passes through a second transparent plate 9 and is incident on the fθ lens 51.

The second transparent plate 9 is a cemented element that includes a parallel base plate (a base component) 9-1 made of glass and a photo-curing resin layer 9-2 formed on a surface of the base plate 9-1. The photo-curing resin layer 9-2 has a diffractive lens structure formed on the outer surface, i.e., on a beam exiting surface 9c (which will be occasionally referred to as a diffractive surface). The diffractive lens structure is formed as a part of rotationally symmetrical pattern to compensate for lateral chromatic aberration in the main scanning direction caused by optical dispersion of material of the fθ lens 51. A beam incident surface 9a and a cemented surface 9b of the second transparent plate 9 are flat surfaces that are perpendicular to the optical axis of the fθ lens 51. A base curve of the diffractive surface 9c is a rotationally symmetrical aspherical surface.

The second transparent plate 9 as a cemented element is manufactured similarly to the cemented lens 6 of the first embodiment, i.e., in accordance with the method including the steps (a) to (d) described in the first embodiment.

The fθ lens 51 includes a first lens 61 and a second lens 71 arranged in this order from the polygonal mirror side to the objective surface side. The first lens 61 is a positive meniscus lens whose concave surface faces the polygonal mirror 4. The first lens 61 is located near the polygonal mirror 4. The second lens 71 is located near the objective surface B. The second lens 71 has a large positive power in the auxiliary scanning direction.

A beam incident surface 61a of the first lens 61 is a spherical surface. A beam exiting surface 61b of the first lens 61 and a beam exiting surface 71b of the second lens 71 are rotationally symmetrical aspherical surfaces. A beam incident surface 71a of the second lens 71 is an anamorphic aspherical surface.

The following TABLEs 5 through 8 show the numerical construction of the scanning optical system 200 according to the second embodiment. TABLE 5 shows the basic construction of ry, rz, n and vd, TABLE 6 shows conic constants and aspherical coefficients to define the rotational symmetrical aspherical surfaces, TABLE 7 shows various coefficients defining the anamorphic aspherical surface (7a), and TABLE 8 shows coefficients defining the diffractive lens structure of the diffractive surface 9c.

A surface number 0 represents the reflection surface of the polygonal mirror 4, surface numbers 1 through 3 represent the beam incident surface 9a, the cemented surface 9b and the diffractive surface 9c of the second transparent plate 9, respectively, surface numbers 4 and 5 represent the incident and beam exiting surfaces 61a and 61 b of the first lens 61, surface numbers 6 and 7 represent the incident and beam exiting surfaces 71a and 71b of the second lens 71.

TABLE 5
f = 200.0 mm fb = 90.0 mm

| Surface | | | | | |
|---|---|---|---|---|---|
| Number | ry | rz | d | n | νd |
| 0 | ∞ | — | 15.0 | — | — |
| 1 | ∞ | — | 1.5 | 1.511 | 64.1 |
| 2 | ∞ | — | 0.2 | 1.522 | 42.7 |
| 3 | 1519.8 | — | 20.0 | — | |
| 4 | −130.3 | — | 8.0 | 1.486 | 57.4 |
| 5 | −55.4 | — | 106.6 | — | |
| 6 | −760.0 | 29.0 | 4.0 | 1.486 | 57.4 |
| 7 | −2900.0 | — | — | — | — |

TABLE 6

| Surface | | | | |
|---|---|---|---|---|
| Number | κ | A₄ | A₆ | A₈ |
| 3 | −1.000 | 3.032 × 10⁻⁷ | 0.000 | 0.000 |
| 5 | 0.000 | 2.770 × 10⁻⁷ | 0.000 | 0.000 |
| 7 | 0.000 | −7.840 × 10⁻⁸ | 0.000 | 0.000 |

TABLE 7

| | | | |
|---|---|---|---|
| ry | −760.0 | rz0 | 29.0 |
| κ | 0.000 | AS₁ | −6.000 × 10⁻⁷ |
| AM₄ | 5.000 × 10⁻⁸ | AS₂ | −1.330 × 10⁻⁶ |
| AM₆ | −5.500 × 10⁻¹² | AS₃ | 0.000 |
| AM₈ | 1.900 × 10⁻¹⁶ | AS₄ | 4.000 × 10⁻¹¹ |
| — | — | AS₆ | 0.000 |

TABLE 8

| Surface Number | P₂ | P₄ | P₆ |
|---|---|---|---|
| 3 | −2.200 × 10⁻¹ | −2.600 × 10⁻⁴ | 0.000 |

FIG. 7 is a graph showing lateral chromatic aberration of the scanning optical system 200 according to the second embodiment. FIG. 7 shows that the diffractive lens structure formed on the diffractive surface 9c compensates for the lateral chromatic aberration. The pattern of the diffractive lens structure can be accurately transformed to the photo-curing resin layer, which allows to keep a good optical performance as designed.

Third Embodiment

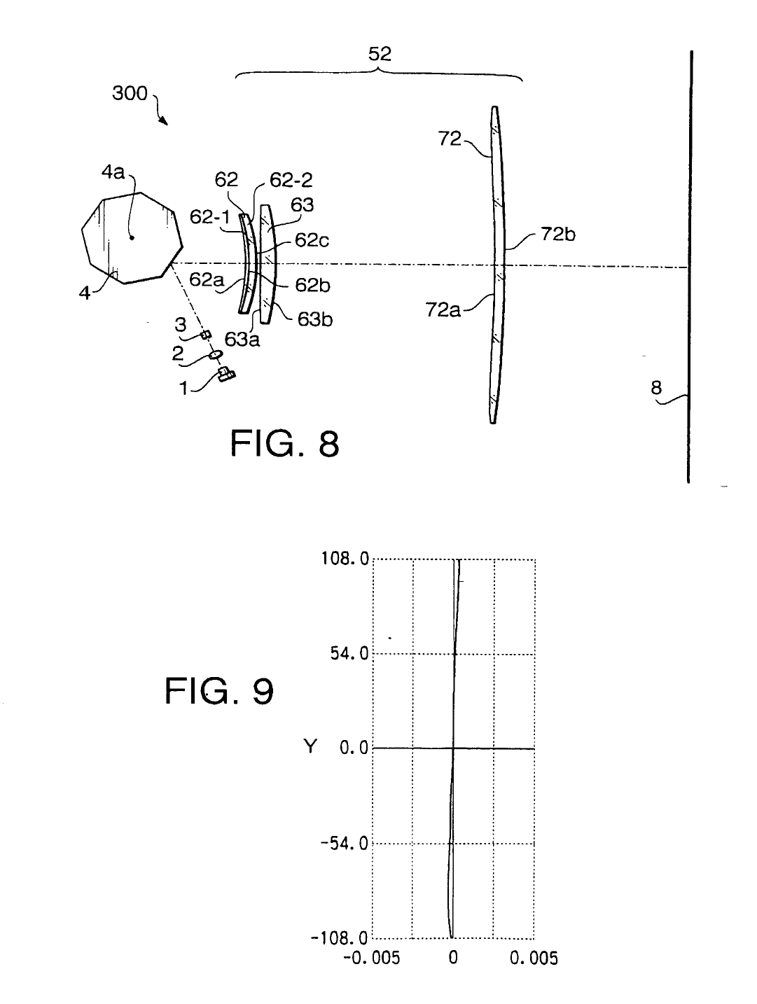

FIG. 8 is a diagram illustrating a basic construction of a scanning optical system 300 according to the third embodiment.

The scanning optical system 300 is provided with the laser diode 1, the collimator lens 2, the cylindrical lens 3, the polygonal mirror 4 and a fθ lens 52.

The fθ lens 52 consists of a first lens 62, a second lens 63 and a third lens 72 arranged in this order from the polygonal mirror 4 to the objective surface 8. The first lens 61 is a positive meniscus lens whose concave surface is directed to the polygonal mirror 4. The second lens 63 is a plano-convex lens whose flat surface is directed to the polygonal mirror 4. The first and second lenses 62 and 63 are located near the polygonal mirror 4. The third lens 72 is located near the objective surface 8, having a large positive power in the auxiliary scanning direction.

The first lens 62 is a cemented lens (a cemented element) that consists of a base lens (a base component) 62-2 made of thermoplastic resin and a photo-curing resin layer 62-1 attached on a surface of the base lens 62-2. The photo-curing resin layer 62-1 has a diffractive lens structure formed on the outer surface, i.e., on a beam incident surface 62a, which will be occasionally referred to as a diffractive surface hereinafter. The diffractive lens structure is formed as a part of rotationally symmetrical pattern to correct lateral chromatic aberration in the main scanning direction due to optical dispersion of material of the fθ lens 52.

The first lens 62 as a cemented element is manufactured through the method including the steps (a) to (d) described in the first embodiment.

A base curve of the diffractive surface 62a, the cemented surface 62b and the beam exiting surface 62c of the first lens 62 are rotationally symmetrical aspherical surfaces. A beam incident surface 63a of the second lens 63 is a flat surface. A beam exiting surface 63b of the second lens 63 and a beam exiting surface 72b of the third lens 72 are spherical surfaces. A beam incident surface 72a of the third lens 72 is an anamorphic aspherical surface.

The following TABLEs 9 through 12 show the numerical construction of the scanning optical system 300 of the third embodiment. TABLE 9 shows the basic construction of ry, rz, n and vd, TABLE 10 shows conic constants and aspherical coefficients to define the rotational symmetrical aspherical surfaces, TABLE 11 shows various coefficients to define the anamorphic aspherical surface and TABLE 12 shows coefficients to define the diffractive lens structure of the diffractive surface 62a.

TABLE 9
f = 200.0 mm fb = 90.1 mm

| Surface | | | | | |
|---|---|---|---|---|---|
| Number | ry | rz | d | n | νd |
| 0 | ∞ | — | 35.2 | — | — |
| 1 | −83.2 | — | 0.2 | 1.522 | 42.7 |
| 2 | −83.2 | — | 4.8 | 1.486 | 57.4 |
| 3 | −79.6 | — | 2.5 | — | — |
| 4 | — | 7.0 | 1.486 | 57.4 | |
| 5 | −107.0 | — | 106.5 | — | — |
| 6 | −540.0 | 30.0 | 4.0 | 1.486 | 57.4 |
| 7 | −923.0 | — | — | — | — |

TABLE 10

| Surface | | | | |
|---|---|---|---|---|
| Number | κ | A₄ | A₆ | A₈ |
| 1 | 0.000 | 2.800 × 10⁻⁶ | −7.100 × 10⁻¹⁰ | 0.000 |
| 2 | 0.000 | 2.800 × 10⁻⁶ | −7.100 × 10⁻¹⁰ | 0.000 |
| 3 | 0.000 | 3.420 × 10⁻⁷ | 0.000 | 0.000 |
| 5 | 0.000 | 1.700 × 10⁻⁶ | −2.900 × 10⁻¹⁰ | 0.000 |

TABLE 11

| | | | |
|---|---|---|---|
| ry | −540.0 | rz0 | 30.0 |
| κ | 0.000 | AS₁ | −4.000 × 10⁻⁷ |
| AM₄ | 1.270 × 10⁻⁷ | AS₂ | −9.000 × 10⁻⁷ |
| AM₆ | −5.800 × 10⁻¹² | AS₃ | 0.000 |
| AM₈ | 1.200 × 10⁻¹⁶ | AS₄ | −3.600 × 10⁻¹² |
| — | — | AS₆ | 2.360 × 10⁻¹⁵ |

TABLE 12

| Surface Number | P₂ | P₄ | P₆ |
|---|---|---|---|
| 1 | −1.200 × 10⁻¹ | −2.500 × 10⁻⁵ | 0.000 |

FIG. 9 is a graph showing lateral chromatic aberration of the scanning optical system 300 according to the third embodiment. FIG. 9 shows that the diffractive lens structure formed on the diffractive surface 62a corrects the lateral chromatic aberration. The pattern of the diffractive lens structure can be accurately transformed to the photo-curing resin layer, which allows to keep a good optical performance as designed.

Fourth Embodiment

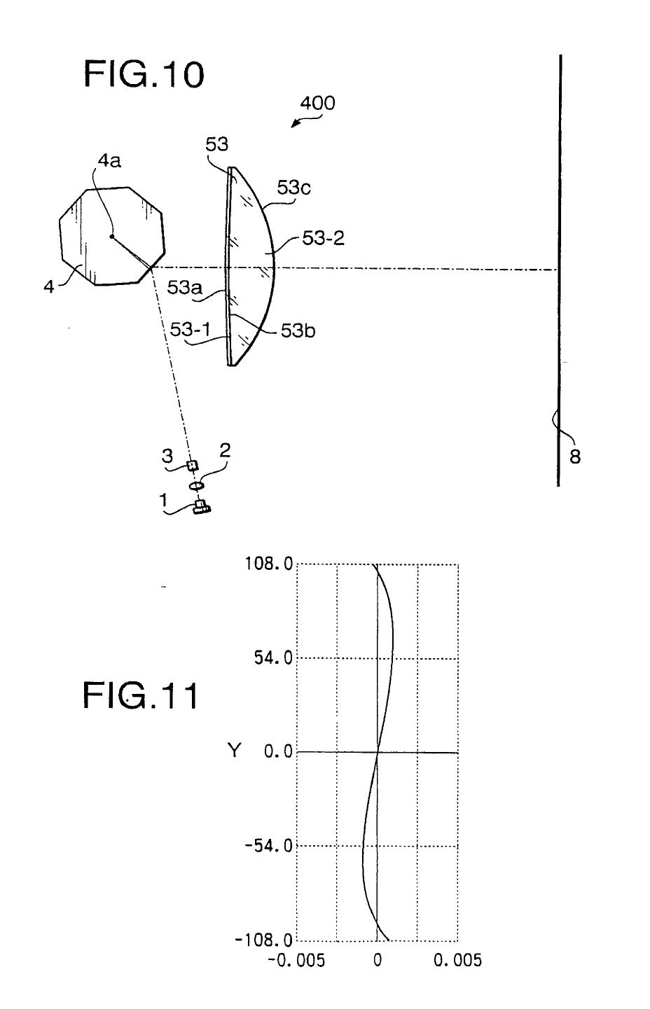

FIG. 10 is a diagram illustrating a basic construction of a scanning optical system 400 according to the fourth embodiment.

The scanning optical system 400 is provided with the laser diode 1, the collimator lens 2, the cylindrical lens 3, the polygonal mirror 4 and a fθ lens 53.

The fθ lens 53 consists of a single bi-convex lens located near the polygonal mirror 4. The fθ lens 53 is a cemented lens (a cemented element) that consists of a base lens (a base component) 53-2 made of thermoplastic resin and a photo-curing resin layer 53-1 attached on a surface of the base lens 53-2. The photo-curing resin layer 53-1 has a diffractive lens structure formed on the outward surface, i.e., on a beam incident surface 53a and therefore, the beam incident surface 53a is referred to as a diffractive surface. The diffractive lens structure is formed as a part of rotationally symmetrical pattern to correct lateral chromatic aberration in the main scanning direction due to optical dispersion of material of the fθ lens 53.

The fθ lens 53 as a cemented element is manufactured through the method including the steps (a) to (d) described in the first embodiment.

A base curve of the diffractive surface 53a and the cemented surface 53b of the fθ lens 53 are rotationally symmetrical aspherical surfaces. A beam exiting surface 53c of the fθ lens 53 is an anamorphic aspherical surface.

The following TABLEs 13 through 16 show the numerical construction of the scanning optical system 400 of the fourth embodiment. TABLE 13 shows the basic construction of ry, rz, n and vd, TABLE 14 shows conic constants and aspherical coefficients to define the rotational symmetrical aspherical surfaces, TABLE 15 shows various coefficients to define the anamorphic aspherical surface and TABLE 16 shows coefficients to define the diffractive lens structure of the diffractive surface 53a.

TABLE 13
f = 134.9 mm fb = 130.9 mm

| Surface | | | | | |
|---|---|---|---|---|---|
| Number | ry | rz | d | n | νd |
| 0 | ∞ | — | 32.5 | — | — |
| 1 | 283.0 | — | 0.2 | 1.508 | 49.5 |
| 2 | 283.0 | — | 22.0 | 1.486 | 57.4 |
| 3 | −86.5 | −17.84 | — | — | — |

TABLE 14

| Surface | | | | |
|---|---|---|---|---|
| Number | κ | A₄ | A₆ | A₈ |
| 1 | 0.000 | −1.060 × 10⁻⁶ | 2.700 × 10⁻¹⁰ | −3.340 × 10⁻¹⁴ |
| 2 | 0.000 | −1.060 × 10⁻⁶ | 2.700 × 10⁻¹⁰ | −3.340 × 10⁻¹⁴ |

TABLE 15

| | | | |
|---|---|---|---|
| ry | −86.5 | rz0 | −17.84 |
| κ | 0.000 | AS₁ | 1.700 × 10⁻⁵ |
| AM₄ | −2.230 × 10⁻⁷ | AS₂ | 1.700 × 10⁻⁶ |
| AM₆ | −1.330 × 10⁻¹⁰ | AS₃ | 4.800 × 10⁻⁹ |
| AM₈ | 8.540 × 10⁻¹⁵ | AS₄ | −2.230 × 10⁻⁹ |
| — | — | AS₆ | −3.400 × 10⁻¹⁴ |

TABLE 16

| Surface Number | P₂ | P₄ | P₆ |
|---|---|---|---|
| 3 | −1.550 × 10⁻¹ | 0.000 | 0.000 |

FIG. 11 is a graph showing lateral chromatic aberration of the scanning optical system 400 according to the fourth embodiment. FIG. 11 shows that the diffractive lens structure formed on the diffractive surface 53a corrects the lateral chromatic aberration. The pattern of the diffractive lens structure can be accurately transformed to the photo-curing resin layer, which allows to keep a good optical performance as designed.

The present disclosure relates to subject matter contained in Japanese Patent Applications No. 2001-376823 filed on Dec. 11, 2001, which is expressly incorporated herein by reference in its entirety.

What is claimed is:

1. A scanning optical system, comprising:
a light source that emits a laser beam;
a deflector that deflects a beam emitted by said light source; and
an imaging optical system that converges the beam deflected by said deflector to form a beam spot on an objective surface,
wherein at least one optical element located between said deflector and the objective surface is a cemented optical element having a base component and a photo-curing resin layer attached on a surface of said base component, said photo-curing resin layer having a diffractive lens structure formed on the outer surface thereof.

2. The scanning optical system according to claim 1, wherein said base component of said cemented element is made of thermoplastic resin formed in accordance with an injection molding process.

3. The scanning optical system according to claim 1, wherein said base component of said cemented optical element is made of glass.

4. The scanning optical system according to claim 1, wherein said cemented optical element has a function of a lens as a whole.

5. The scanning optical system according to claim 1, wherein said imaging optical system includes a refractive optical element, said diffractive lens structure compensating for aberration caused by characteristics of said refractive optical element in a main scanning direction.

6. The scanning optical system according to claim 5, wherein the aberration includes lateral chromatic aberration.

7. The scanning optical system according to claim 1, wherein said imaging optical system includes a plurality of optical elements, said cemented optical element being included in said plurality of optical elements.

8. The scanning optical system according to claim 1, wherein said imaging optical system includes only one optical element, said cemented optical element being said at least one optical element.

9. The scanning optical system according to claim 1, wherein said cemented optical element is not included in said imaging optical system.

10. A scanning optical system, comprising:
a light source that emits a laser beam;
a deflector that deflects a beam emitted by said light source; and
an imaging optical system that converges the beam deflected by said deflector to form a beam spot on an objective surface,
wherein at least one optical element located between said deflector and the objective surface is a cemented element having a base component and a thermo-curing resin layer attached on a surface of said base component, said thermo-curing resin layer having a diffractive lens structure formed on the outer surface thereof.

11. The scanning optical system according to claim 10, wherein said base component of said cemented element is made of thermoplastic resin formed in accordance with an injection molding process.

12. The scanning optical system according to claim 10, wherein said base component of said cemented optical element is made of glass.

13. The scanning optical system according to claim 10, wherein said cemented optical element has a function of a lens as a whole.

14. The scanning optical system according to claim 10, wherein said imaging optical system includes a refractive optical element, said diffractive lens structure compensating for aberration caused by characteristics of said refractive optical element in a main scanning direction.

15. The scanning optical system according to claim 14, wherein the aberration includes lateral chromatic aberration.

16. The scanning optical system according to claim 10, wherein said imaging optical system includes a plurality of optical elements, said cemented optical element being included in said plurality of optical elements.

17. The scanning optical system according to claim 10, wherein said imaging optical system includes only one optical element, said cemented optical element being said at least one optical element.

18. The scanning optical system according to claim 10, wherein said cemented optical element is not included in said imaging optical system.
